(19) United States
(12) Patent Application Publication
(10) Pub. No.: US 2023/0065824 A1
(43) Pub. Date: Mar. 2, 2023

(54) Method and System for Harmonious Homogeneous Flavor and Color Distribution with Powdered Flavoring in Cheesecake and Cheesecake Baked Goods

(71) Applicant: Hustle Citi Inc dba Ann's Flavored Cheesecake, Harvey, IL (US)

(72) Inventors: Donna Newman, Harvey, IL (US); Louis McWilliams, Tinley Park, IL (US)

(21) Appl. No.: 17/461,799

(22) Filed: Aug. 30, 2021

(51) Int. Cl. A21C 1/14; A21D 10/04; A23L 5/40; A23C 19/09; A21C 1/00

(52) U.S. Cl. CPC A21C 1/146; A21D 10/04; A23L 5/40; A23C 19/0912; A21C 1/006; A23V 2002/00

(57) ABSTRACT

A method of manufacturing a homogeneous cheesecake mix is disclosed. More specifically, the method creates a harmonious and homogeneous cheesecake with the flavoring and coloring being distributed along the cheesecake mix. The present invention requires a cheesecake mix, a flavoring blend, a mixing bowl, a plurality of sensors, and a mechanical sensor. The initial amount of flavoring blend and the cheesecake mix are added into the mixing bowl to make an initial mixture. The initial mixture is mixed into a batter using a mechanical mixer. An incremental amount of flavoring blend is added and mixed into the batter to make a cheesecake mix. The cheesecake mix is then probed for color and concentration. Repeat the last two steps until desired color and flavor is achieved. Finally, the mechanical mixer is stopped to form the homogeneous cheesecake mix once the desired color and flavor is achieved.

### FIELD OF THE INVENTION

The present invention generally relates to baking methods, specifically a method and system for harmonious homogeneous flavor and color distribution with powdered flavoring in cheesecake and cheesecake baked goods.

### BACKGROUND OF THE INVENTION

In today's society, more and more bakers desire customized homogenous flavor and color in their baked goods, especially in cheesecakes. In conventional methods of baking cheesecakes, bakers often rely on a pre-made/base cheesecake mix with flavoring and color already added in as a set standard. This poses limitations as bakers may desire a different flavor and color derived from the pre-made cheesecake mix. Bakers would often add in or formulate their own flavoring and coloring blends to try to enhance the base cheesecake mix, causing increased lead times in production. Additionally, these added formulations complicate the process, making it easy to make errors and mistakes.

The present invention aims to solve these limitations. The present invention introduces a method of producing homogenous and harmonious flavor and color distribution in cheesecakes and cheesecake baked goods. The present invention utilizes a pre-made powder flavoring blend that simplifies the process of enhancing and customizing the base cheesecake mix. The present invention allows bakers to control how much pre-made powder flavoring to administer along the cheesecake mix, creating numerous possibilities and cutting down on lead times.

### BRIEF DESCRIPTION OF THE DRAWINGS

FIG. 1 is a flowchart illustrating the overall process for the present invention.

FIG. 2 is a flowchart illustrating the process of measuring the initial amount of flavoring blend and the initial amount of cheesecake mix.

FIG. 3 is a flowchart illustrating the process of measuring the incremental amount of flavoring blend.

FIG. 4 is a flowchart illustrating the process of probing the cheesecake mix for a set pigment threshold and a set concentration threshold.

FIG. 5 is a flowchart illustrating the process of stopping the mechanical mixer.

### DETAILED DESCRIPTION OF THE INVENTION

All illustrations of the drawings are for the purpose of describing selected versions of the present invention and are not intended to limit the scope of the present invention.

The present invention is a method of manufacturing a homogeneous cheesecake mix. More specifically, the method creates a harmonious and homogeneous cheesecake with the flavoring and coloring being distributed along the cheesecake mix. In the preferred embodiment of the present invention, the method utilizes powdered flavoring suited for enhancing the flavoring and coloring of cheesecakes.

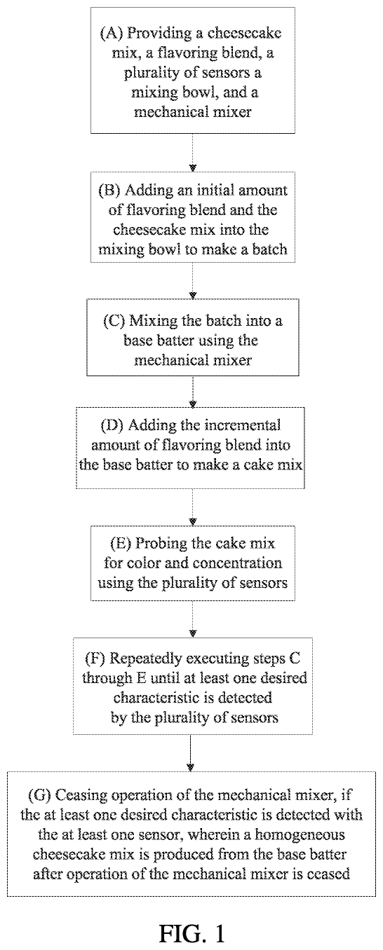

As can be seen in FIG. 1, the method of the present invention follows an overall process that allows for an effective and efficient distribution of powdered flavoring blend into a cheesecake mix. In order to execute the overall process for the method of the present invention, the present invention requires a cheesecake mix, a flavoring blend, a mixing bowl, a plurality of sensors, and a mechanical mixer (Step A). In the preferred embodiment of the present invention, the flavoring blend is a powdered flavoring that provides flavor and color to the cheesecake mix. In one embodiment, the flavoring blend may take the form of a chocolate flavoring agent that darkens and enhances the taste of the cheesecake mix to a more chocolate flavor and color. In another embodiment, the flavoring blend may take the form of a sweetener infused with food coloring. In the preferred embodiment of the present invention, the mechanical mixer is a standing bowl mixer, but may take the form of any other suitable mechanical mixer, such as, but not limited to mixing vats, tumblers, vibrational mixers, or any other suitable mechanical mixer.

In accordance with the preferred embodiment of the present invention, the initial amount of flavoring blend and the cheesecake mix are added into the mixing bowl to make an initial mixture (Step B). the initial mixture is mixed into a batter using a mechanical mixer (Step C). An incremental amount of flavoring blend is added and mixed into the batter to make a cheesecake mix (Step D). The cheesecake mix is then probed for color and concentration using the plurality of sensors (Step E). In the preferred embodiment of the present invention, the plurality of sensors may take the form of sensors that can measure pigment and flavor concentrations. In one embodiment, the plurality of sensors may take the form of optical sensors that aid in determining the desired pigment of the cheesecake mix. In various embodiments, the plurality of sensors may take the form of a series of relevant sensory implements that aids in measuring the concentration and pigment of the cheesecake mix. These sensory implements may include Ph litmus tests, turbidity sensory implements, viscosity sensory implements or any other suitable sensory implement. Steps C-E are repeatedly executed until at least one desired characteristic is detected by the plurality of sensors (Step F). Finally, the mechanical mixer ceases operation if the at least one desired characteristic is detected with the at least one sensor where a homogeneous cheesecake mix is produced from the base batter after operation of the mechanical mixer is ceased (Step G).

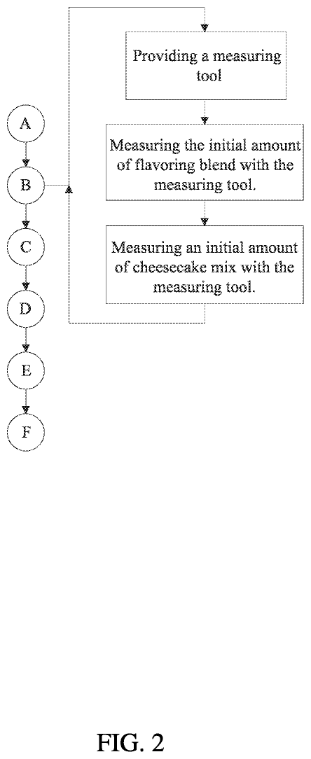

As can be seen in FIG. 2, Step B begins by providing a measuring tool. The initial amount of flavoring blend is measured with the measuring tool. Additionally, the initial amount of cheesecake mix is measured with the measuring tool. Following step B, step C begins by mixing the initial mixture into a batter using the mechanical mixer. In the preferred embodiment of the present invention, the measuring tool may take the form of any suitable measuring tool such as, but not limited to volumetric scoops, powder measures, batter measures, or any other measuring implement.

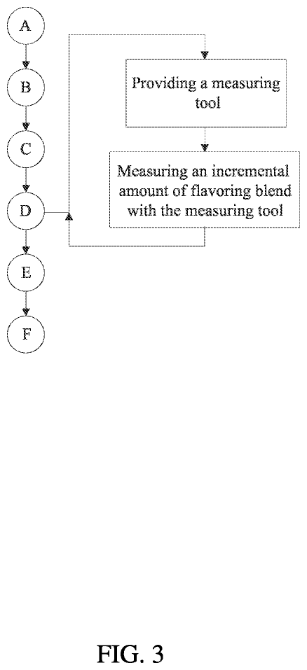

Following Step C, Step D begins by providing a measuring tool to measure an incremental amount of flavoring blend, or specified incremental flavoring quantity, as shown in FIG. 3. In the preferred embodiment of the present invention, the specified incremental flavoring quantity is between 0 to 18 grams. More specifically, the incremental amount of flavoring blend may take the form of a set amount of flavoring blend to add in right after the initial mixture is mixed into a batter. In the preferred embodiment of the present invention, the measuring tool may take the form of any suitable measuring tool such as, but not limited to volumetric scoops, powder measures, or any other measuring implement.

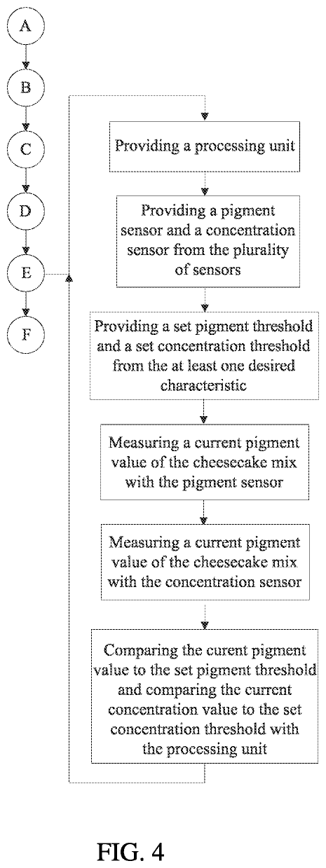

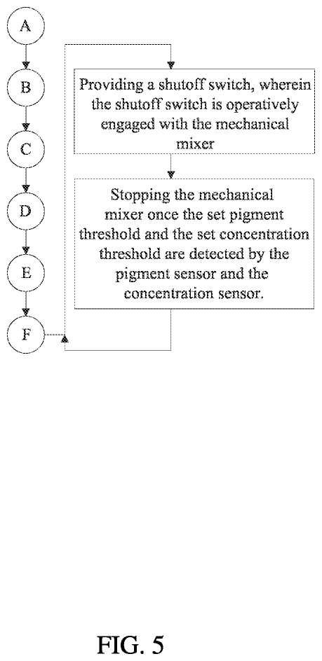

After Step D concludes, Step E begins by providing processing unit. Additionally, a pigment sensor and a concentration sensor from the plurality of sensors is provided, as shown in FIG. 4. Furthermore, a set pigment threshold and a set concentration threshold are provided from the at least one desired characteristic. A current pigment value of the cheesecake mix is measured with the pigment sensor. In the preferred embodiment, the pigment threshold may be set to a contrast limit threshold. A current concentration value of the cheesecake mix is measured with the concentration sensor. In the preferred embodiment, the set concentration threshold may take the form of a pH limit threshold. The current pigment value is compared to the set pigment threshold using the processing unit. Additionally, the current concentration value is compared to the set concentration threshold using the processing unit. In the preferred embodiment, the processing unit may take the form of a comparator device that compares the concentration and pigment current values with the set concentration and pigment thresholds, respectively. If these thresholds are not met, step F begins by executing a plurality of necessary iterations for steps (C) through (E), where each necessary iteration gets closer to a desired color and concentration. Once these thresholds are met, step F concludes. Finally, step G begins by providing a shutoff switch, where the shutoff switch is operably engaged with the mechanical driver as shown in FIG. 5. In the preferred embodiment, the shutoff switch may take the form of an electrical cutoff switch that is operatively engaged with the mechanical mixer and the plurality of sensors, where the shutoff switch is configured to turn off the mechanical mixer once the plurality of sensors detects at least one desired characteristic in the cheesecake mix. The operation of the mechanical mixer is ceased through the shutoff switch if the current pigment value corresponds to the set pigment threshold and if the current concentration value corresponds to the set concentration threshold.

Although the invention has been explained in relation to its preferred embodiment, it is to be understood that many other possible modifications and variations can be made without departing from the spirit and scope of the invention as hereinafter claimed.

What is claimed is:

1. A method for manufacturing a homogeneous cheesecake mix, the method comprises the steps of:
(A) providing a cheesecake mix, a flavoring blend, a mixing bowl, a plurality of sensors, and a mechanical mixer;
(B) adding an initial amount of flavoring blend and the cheesecake mix into the mixing bowl to make an initial mixture;
(C) agitating the initial mixture with the mechanical mixer in order to produce a base batter;
(D) adding the incremental amount of flavoring blend into the batter to make a cheesecake mix;
(E) probing the cheesecake mix for color and concentration with the plurality of sensors;
(F) repeatedly executing steps (C) through (E) until at least one desired characteristic is detected by the plurality of sensors; and
(G) ceasing operation of the mechanical mixer, if the at least one desired characteristic is detected with the at least one sensor, wherein a homogeneous cheesecake mix is produced from the base batter after operation of the mechanical mixer is ceased.

2. The method for manufacturing a homogeneous cheesecake mix as claimed in claim 1, wherein the specified flavoring blend is a powdered flavoring blend.

3. The method for manufacturing a homogeneous cheesecake mix, as claimed in claim 1 comprises the steps of:
providing a measuring tool;
measuring the initial amount of flavoring blend with the measuring tool; and
measuring the initial amount of cheesecake mix with the measuring tool.

4. The method for manufacturing a homogeneous cheesecake mix as claimed in claim 1, wherein the mechanical mixer is a standing bowl mixer.

5. The method for manufacturing a homogeneous cheesecake mix as claimed in claim 1 comprises the steps of:
providing a measuring tool; and
measuring the incremental amount of flavoring blend with the measuring tool.

6. The method for manufacturing a homogeneous cheesecake mix as claimed in claim 1 comprises the steps of:
providing a processing unit;
providing a pigment sensor and a concentration sensor from the plurality of sensors;
providing a set pigment threshold and a set concentration threshold from the at least one desired characteristic;
measuring a current pigment value of the cheesecake mix with the pigment sensor;
measuring a current concentration value of the cheesecake mix with the concentration sensor; and
comparing the current pigment value to the set pigment threshold and comparing the current concentration value to the set concentration threshold with the processing unit.

7. The method for manufacturing a homogeneous cheesecake mix as claimed in claim 6 comprises the steps of:
providing a shutoff switch, wherein the shutoff switch is operably engaged with the mechanical mixer; and
ceasing operation of the mechanical mixer through the shutoff switch, if the current pigment value corresponds to the set pigment threshold and if the current concentration value corresponds to the set concentration threshold.

8. The method for manufacturing a homogeneous cheesecake mix, the method as claimed in claim 1, wherein the specified incremental flavoring quantity is between 0 to 18 grams.
